(19) United States
(12) Patent Application Publication
(10) Pub. No.: US 2013/0081801 A1
(43) Pub. Date: Apr. 4, 2013

(54) Methods for Improving Coatings on Downhole Tools

(71) Applicants: Feng Liang, Cypress, TX (US); Bradley L. Todd, Duncan, OK (US); Thomas D. Welton, Duncan, OK (US); Rajesh K. Saini, Cypress, TX (US)

(72) Inventors: Feng Liang, Cypress, TX (US); Bradley L. Todd, Duncan, OK (US); Thomas D. Welton, Duncan, OK (US); Rajesh K. Saini, Cypress, TX (US)

(21) Appl. No.: 13/252,403

(22) Filed: Oct. 4, 2011

(51) Int. Cl. E21B 33/12; E21B 43/00; E21B 34/06; E21B 17/00; B05D 3/10; E21B 43/08

(52) U.S. Cl. 166/192; 427/337; 166/227; 166/316; 166/242.1; 166/177.4

(57) ABSTRACT

The present invention relates to the use of degradable coatings suitable for use on downhole tools. In particular, the present invention relates to pliable coatings for use on downhole tools that have been designed to be able to resist flaking or breaking off of the tool in response to a physical shock. Some embodiments of the present invention provide methods of reacting lactic acid, glycolic acid, or a combination thereof in a polymerization reaction to form a degradable polymer; combining the degradable polymer and a plasticizer to form a coating composition; applying the coating composition to a downhole tool; placing the coated downhole tool into a portion of a subterranean formation; and, hydrolyzing the degradable polymer of the coating composition to release an acid and degrade the coating.

### BACKGROUND

The present invention relates to the use of degradable coatings suitable for use on downhole tools. In particular, the present invention relates to pliable coatings for use on downhole tools that have been designed to be able to resist flaking or breaking off of the tool in response to a physical shock.

A wide variety of downhole tools may be used within a wellbore in connection with recovering desirable fluid or reworking a well that extends into a subterranean formation.

It is sometimes desirable to coat downhole tools with temporary polymer coatings to, for example, prevent plugging or ensure that the coating itself is delivered to the desired location within the downhole environment. By way of example, degradable polymers may be used as coatings wherein the polymer is designed to degrade and release a treatment chemical at a desired time from placement or at a desired downhole temperature. For example, degradable polymers may be used in subterranean formations for applications such as forming coatings for screens to prevent their plugging from contaminants in wellbore fluids or to provide a seal for the screen perforations. Polylactic acid and poly glycolic acid are biodegradable polymers that may be useful as coating materials. These materials can be formulated to have a high melting point, which is useful in harsh downhole conditions. However, these materials can suffer from hard and brittle properties over a wide range of temperatures. It is desirable for a coating to have some degree of pliability at storage or surface conditions as hard and brittle tools tend to break easily during handling and transporting. It is also desirable for a coating to be pliable during usage conditions, particularly as the tool is being placed into the downhole environment, to provide impact resistance.

### SUMMARY OF THE INVENTION

The present invention relates to the use of degradable coatings suitable for use on downhole tools. In particular, the present invention relates to pliable coatings for use on downhole tools that have been designed to be able to resist flaking or breaking off of the tool in response to a physical shock.

Some embodiments of the present invention provide methods comprising: reacting lactic acid, glycolic acid, or a combination thereof in a condensation reaction to form a degradable polymer; combining the degradable polymer and a plasticizer to form a coating composition; applying the coating composition to a downhole tool; placing the coated downhole tool into a portion of a subterranean formation; and, hydrolyzing the degradable polymer of the coating composition to release an acid and degrade the coating.

Other embodiments of the present invention provide methods comprising: reacting lactic acid, glycolic acid, or a combination thereof in a condensation reaction to form a degradable polymer; combining the degradable polymer and a plasticizer to form a coating composition; applying the coating composition to a screen such that the screen openings are substantially occluded by the coating composition; placing the coated screen into a portion of a subterranean formation; and, hydrolyzing the degradable polymer of the coating composition to release an acid and degrade the coating.

The features and advantages of the present invention will be readily apparent to those skilled in the art upon a reading of the description of the preferred embodiments that follows.

### DETAILED DESCRIPTION

The present invention relates to the use of degradable coatings suitable for use on downhole tools. In particular, the present invention relates to pliable coatings for use on downhole tools that have been designed to be able to resist flaking or breaking off of the tool in response to a physical shock.

The present invention provides improved pliable coatings that can be designed to exhibit desired degrees of pliability at different temperatures. The pliable coatings of the present invention have the ability to form durable coatings for subterranean applications such as coating screens or downhole tools. The present invention alters degradable coatings such that they are no longer hard and brittle under manufacturing and storage conditions and sometimes even under downhole conditions. Hard and brittle coatings cause portions of the coating to break off the tool prematurely. Thus, the pliable coatings of the present invention increase the durability of the coating during storage and during usage. These coating also impart to the tools an ease of handling while in storage and while the tools are placed and used in downhole applications. As used herein, “pliability” describes the ability of a material to be flexible or easily bent without breaking. One skilled in the art will recognize that the term “coating” as used herein does not refer only to embodiments wherein the tool is 100% coated. Rather, the degree of coating may be tailored based on the amount of degradable material to be placed and/or based on the desired location for the coating.

In particular, the present invention provides improved coatings comprising polymers and copolymers formed from lactic acid, glycolic acid, or a combination thereof. The polymers and copolymers of lactic acid and glycolic acid may be formed by various methods, including but not limited to, a condensation reaction, a ring opening polymerization reaction, and the like. The exact method used to form the polymers and copolymers will depend on the desired molecular weight and/or degree of branching. By way of example, a condensation procedure may yield a smaller molecular polymer weight while a ring opening procedure may yield a higher molecular weight polymer. It is believed that when such copolymers are formed under stoichiometric or near stoichiometric conditions, they tend to be extremely brittle even at room temperature, thus they are not suitable for use as a coating material on down hole tools. Without being limited by theory, it is believed that the ratio of glycolide to lactide can be adjusted to control the degree of brittleness of the resulting polymers. For example, when crystalline polyglycolic acid (PGA) is co-polymerized with polylactic acid (PLA), the degree of crystallinity is reduced which, in turn, leads to increases in rates of hydration and hydrolysis. Thus, it may be concluded that the degradation time of the copolymer is related to the ratio of monomers used in synthesis. Generally speaking, higher glycolide concentrations lead to faster degradation rates. The exception to this trend is when the glycolide to lactide ratio is 1:1. In certain embodiments, the polymers and copolymers useful in the present invention are formed by a condensation reaction. A condensation reaction is a chemical reaction in which two molecules or moieties (functional groups) combine to form one single molecule, together with the loss of a small molecule. In condensation reactions to create polymers and copolymers formed from lactic acid, glycolic acid, or a combination thereof, the small molecule lost is water.

Below their glass transition temperature, amorphous polymers are usually hard and brittle because of the low mobility of their molecules. Increasing the temperature induces molecular motion resulting in the typical rubber-elastic properties. A constant force applied to a polymer at temperatures above T_{g} results in a viscoelastic deformation, i.e., the polymer begins to creep. Relatively strong intermolecular forces in semicrystalline polymers often prevent softening even above the glass transition temperature. A polymer's elastic modulus changes significantly only at high (melting) temperature. It also depends on the degree of crystallinity, wherein higher crystallinity results in a harder and more thermally stable, but also more brittle material, whereas the amorphous regions provide certain elasticity and impact resistance. Another characteristic feature of semi-crystalline polymers is strong anisotropy of their mechanical properties along the direction of molecular alignment and perpendicular to it.

The present invention provides for plasticized polymer compositions that have depressed melt temperatures or glass transition temperatures relative to the unplasticized polymer composition, which increases the ease with which a downhole tool or component thereof may be formed. As used herein, the term “polymerization reaction” refers to a chemical reaction in which two molecules or moieties (in this case lactic acid and/or glycolic acid) combine to form one single molecule (a polymer). Suitable examples of polymerization reactions include, but are not limited to, condensation reactions, ring opening polymerization reactions, and the like.

In some embodiments, a downhole tool or a component thereof may comprise a polymer formed via a polymerization reaction (such as a condensation reaction) of lactic acid, glycolic acid, or a combination thereof that is then exposed to a plasticizer. In some embodiments, a plasticized polymer composition comprises a polymer and a plasticizer. One skilled in the art should understand that coatings may be of variable thicknesses. Suitable downhole tools for use in the present invention may be any downhole tool suitable for use in a subterranean formation including, but not limited to, testing downhole tools, perforating downhole tools, completion downhole tools, drilling downhole tools, logging downhole tools, treating downhole tools, circulation valve well downhole tools, packers, well screen assemblies, bridge plugs, frac plugs, kickoff plugs, cementing tools, coil tubing, casing, and fishing downhole tools. It should be understood by one skilled in the art that a downhole tool, as described herein, does not include particulates or fluid additives.

By way of nonlimiting example, a downhole tool may be a screen with a plasticized polymer composition coating thereon. In some preferred embodiments, the coating may be used to coated the screen such that the openings are substantially occluded, thereby effectively changing the screen into a pipe. As used herein, the term “substantially occluded” refers to a coating that either completely blocks all of the openings of the screen or blocks at least 90% of the openings. Once placed into a subterranean formation and exposed to formation fluids or fluids passed through the tool, the degradable polymer will degrade, and the screen will reemerge. However, it may be desirable for the coating to be sufficiently strong such that the coating is able to withstand differential pressure for a period of time while the tool is in its pipe form.

The pliable coatings of the present invention generally comprise polymers and copolymers formed from lactic acid, glycolic acid, or a combination thereof via a polymerization reaction and a plasticizer. The coating of the present invention also may include one or more variety of additional additives such as enzymes, chelants, organic acids, bases, surface active agents, oxidizers and other reactive materials which are capable of dissolving, degrading, or dispersing potentially plugging materials, such as, for example, materials commonly found in drilling fluids, filter cakes formed from these drilling fluids, hydraulic fracturing fluids, and high viscosity completion fluid “pills.” Without being limited by theory, it is believed that certain enzymes (e.g., esterases, lipases, etc.) can expedite the degradation of polylactic acid.

Without being limited by theory, it is believed that the pliable coatings of the present invention exhibit lower glass transition temperatures than the degradable material would exhibit on its own. Glass transition or liquid-glass transition is an amorphous polymer specific phenomenon which affects the physical properties of a given polymer above and below glass transition temperature (T_{g}). An amorphous material can undergo a reversible transition from a hard and relatively brittle state into a molten or rubber-like state at its glass transition temperature. Macroscopically, a material below its T_{g} is often hard and brittle. A material above its T_{g} is often soft and flexible or pliable. Depending on desirability, it may be advantageous to provide a degradable polymer of the present invention having a glass transition temperature which is above room or storage temperature. However, even materials that exhibit a T_{g} as low as −15° C. may be suitable so long as they are protected from humidity, provide useful strength, and are not too tacky. One skilled in the art will be aware of additives and methods to control tackiness in the polymer. In some instances, it may be desirable to provide a degradable polymer of the present invention having a glass transition temperature which is below subterranean usage temperatures. Without being limited by theory, it is believed that a plasticizer can lower the glass transition temperature of a polymer suitable for use in the present invention.

In some instances, the selected degradable materials are designed to degrade and release a treatment chemical at a desired time from placement or downhole temperature. For example, degradable polymers may be used in subterranean formations for applications such as forming coatings for a screen that is placed into the wellbore at a location having a filter cake that is susceptible to degradation when exposed to an acid. The polymers and copolymers formed from lactic acid, glycolic acid, or a combination thereof via a polymerization reaction and a plasticizer will hydrolyze over time in the presence of water to produce an acid that may, in turn, degrade a nearby filter cake or scale such as CaCO₃.

As used herein, the term “degradation,” or “degradable,” refers to the conversion of materials into smaller components, intermediates, or end products by the result of solubilization, hydrolytic degradation, biologically formed entities (e.g., bacteria or enzymes), chemical reactions, thermal reactions, reactions induced by radiation, or any other suitable mechanism. The term “polymer(s),” as used herein, does not imply any particular degree of polymerization; for instance, oligomers are encompassed within this definition.

A method of the present invention generally includes applying a pliable coating comprising a polymer or copolymer formed from lactic acid, glycolic acid, or a combination thereof via a polymerization reaction and a plasticizer to a tool useful in a subterranean operation and allowing the coating to degrade once placed into the subterranean environment. Another example of a method of the present invention is a method of applying a coating comprising a polymer or copolymer formed from lactic acid, glycolic acid, or a combination thereof via a polymerization reaction and a plasticizer to a well bore screen useful in subterranean operation and allowing the coating to mostly or completely cover the screen opening such that the screen effectively becomes a pipe when coated. In some embodiments, the coating comprising a polymer or copolymer formed from lactic acid, glycolic acid, or a combination thereof via a polymerization reaction and a plasticizer may be applied to testing downhole tools, perforating downhole tools, completion downhole tools, drilling downhole tools, logging downhole tools, treating downhole tools, circulation valve well downhole tools, packers, well screen assemblies, bridge plugs, frac plugs, kickoff plugs, cementing downhole tools, coil tubing, casing, and fishing downhole tools.

The degradability of a polymer depends at least in part on its backbone structure. For instance, the presence of hydrolysable and/or oxidizable linkages in the backbone often yields a material that will degrade as described herein. The rates at which such polymers degrade are dependent on the type of repetitive unit, composition, sequence, length, molecular geometry, molecular weight, morphology (e.g., crystallinity, size of spherulites, and orientation), hydrophilicity, hydrophobicity, surface area, and additives. Also, the environment to which the polymer is subjected may affect how it degrades, e.g., temperature, presence of moisture, oxygen, microorganisms, enzymes, pH, and the like. In some instances, the degradable material may be capable of releasing a desirable degradation product, e.g., an acid and/or an alcohol, during its degradation.

The incorporation of plasticizers into the polymer or copolymer formed from lactic acid, glycolic acid, or a combination thereof via a polymerization reaction should decrease the T_{g} of the degradable material and allow it to have the desirable pliability to increase impact resistance at storage and usage conditions. The plasticizers may be present in an amount sufficient to provide the desired characteristics, for example, a desired pliability to the generated degradable particulates. Pliability in the coatings may also be desirable, for example, to at least partially prevent cracking. The plasticizers are preferably intimately incorporated within the polymerization reaction product. Examples of plasticizers suitable for use in the present invention include, but are not limited to, polyols such as glycerol, propylene glycol, polyethylene glycol (PEG), and polypropylene glycol (and epoxy derivatives thereof); polyethylene oxide; organic esters such as citrate esters, e.g., tributyl citrate oligomers, triethyl citrate, acetyltributyl citrate, acetyltriethyl citrate, trioctyl citrate, acetyl trioctyl citrate, trihexyl citrate, acetyl trihexyl citrate, and trimethyl citrate; glucose monoesters; partially fatty acid esters; PEG monolaurate; acetic esters including triacetin; poly(e-caprolactone); poly(hydroxybutyrate); glycerin-1-benzoate-2, 3-dilaurate; glycerin-2-benzoate-1,3-dilaurate; bis(butyl diethylene glycol)adipate; 1,2-cyclohexane dicarboxylic acid diisononyl ester; alkyl sulfonic acid phenyl ester; ethylphthalylethyl glycolate; glycerin diacetate monocaprylate; diacetyl monoacyl glycerol; polypropylene glycol (and epoxy derivatives thereof); poly(propylene glycol)dibenzoate, dipropylene glycol dibenzoate; glycerol; ethyl phthalyl ethyl glycolate; poly(ethylene adipate)distearate; adipate-based plasticizers such as di-iso-butyl adipate and bis(butyl diethylene glycol)adipate; and combinations thereof. The choice of an appropriate plasticizer will depend on the particular application of use. When desirable, certain degradable polymers such as lactides are suitable as plasticizers as well. More pliable degradable materials may be beneficial in certain chosen applications. The addition of presence of a plasticizer can affect the relative degree of pliability. Also, the relative degree of crystallinity and amorphousness of the degradable material can affect the relative hardness of the degradable materials.

In some non-limiting cases, for example, where resistance to water and oil may be desirable or where slower degradation of the polymer is desirable, phthalate-based plasticizers may be used. Suitable examples of phthalate-based plasticizers include, bis(2-ethylhexyl) phthalate, diisononyl phthalate, bis(n-butyl)phthalate, butyl benzyl phthalate, diisodecyl phthalate, di-n-octyl phthalate, diisooctyl phthalate, diethyl phthalate, etc.

In a non-limiting embodiment, other plasticizers may also be chosen based on a desirable characteristic. For example, plasticizers that are resistant to high temperatures include trimethyl trimellitate, tri-(2-ethylhexyl) trimellitate, tri-(n-octyl,n-decyl) trimellitate, etc. Plasticizers that are resistant to UV light include bis(2-ethylhexyl)adipate, dimethyl adipate, monomethyl adipate, and dioctyl adipate.

The plasticizers should be present in the coating in an amount sufficient to increase the pliability of the degradable compound at a desired temperature. In some embodiments, the plasticizers are present in an amount in the range of from about 0.25% to about 40% by weight of the coating composition.

In some embodiments, the glass transition temperature of the coating is lower than room temperature. In some embodiments, the degradable polymer is semi-crystalline at room temperature. The benefit of having such a glass transition temperature is that the coating is pliable and soft at storage conditions which promotes ease of handling and protects the coating from breaking or falling apart. In some embodiments, the glass transition temperature is above about −15° C., above about 0° C., or above about 35° C. Where desirable, the glass transition temperature of the degradable polymer may be tweaked to a specific temperature by a variety of factors, including but not limited to, the choice of polymer, plasticizer, and/or concentration of plasticizer.

In some embodiments the present invention provides methods comprising (1) reacting lactic acid, glycolic acid, or a combination thereof in a polymerization reaction to form a degradable polymer; (2) combining the degradable polymer and a plasticizer to form a coating composition; (3) applying the coating composition to a downhole tool; (4) placing the coated downhole tool into a portion of a subterranean formation; and, (5) hydrolyzing the degradable polymer of the coating composition to release an acid and degrade the coating.

In other embodiments the present invention provides methods comprising (1) reacting lactic acid, glycolic acid, or a combination thereof in a polymerization reaction to form a degradable polymer; (2) combining the degradable polymer and a plasticizer to form a coating composition; (3) applying the coating composition to a screen such that the screen openings are substantially occluded by the coating composition; (4) placing the coated screen into a portion of a subterranean formation; and, (5) hydrolyzing the degradable polymer of the coating composition to release an acid and degrade the coating.

To facilitate a better understanding of the present invention, the following examples of preferred embodiments are given. In no way should the following examples be read to limit, or to define, the scope of the invention.

### EXAMPLE 1

In this Example, various polylactic acid samples and polylactic acid-polyglycolic acid copolymer samples (PLA-PGA) were tested for their glass transition temperatures. The amorphous PLA samples used were “ECORENE 60” which exists as a high molecular weight powder, commercially available from ICO Polymers®, Allentown, Pa. The results of ECORENE 60 are shown in Table 1 below along with the relevant concentrations in parts per hundred rubber (PHR).

TABLE 1
Plasticized PLA and their glass transition temperatures.

| | PLA | | | | |
|---|---|---|---|---|---|
| Expt | Amorphous | | Plasticizer | | T_{g} ° C. |
| No. | PLA | PHR | Plasticizer | PHR | (° F.) |
| 1 | ECORENE 60 | 100 | N/A | N/A | 58 (136) |
| 2 | ECORENE 60 | 100 | Lactide | 18 | 27 (81) |
| 3 | ECORENE 60 | 100 | Lactide | 30 | 20 (68) |
| 4 | ECORENE 60 | 100 | Lactide | 40 | 14 (57) |
| 5 | ECORENE 60 | 100 | Dibutyl Phthalate | 24 | 12 (54) |
| 6 | ECORENE 60 | 100 | Dibutyl Phthalate | 30 | 4 (39) |
| 7 | ECORENE 60 | 100 | Triacetin | 30 | 2 (36) |
| 8 | ECORENE 60 | 100 | Tributyl Citrate | 30 | 6 (43) |
| 9 | ECORENE 60 | 100 | Diethyl | 30 | 12 (54) |
| | | | bis(hydroxy- | | |
| | | | methyl)malonate | | |

The results of the plasticized PLA-PGA copolymers are shown in Table 2 below. The PLA-PGA copolymers were obtained from C&C Reactive Coatings, LLC by reacting 90% lactic acid (“PURAC® HIPURE 90” commercially available from PURAC America, Inc., Lincolnshire, Ill.) with 70% glycolic acid (“DUPONT GLYCOLIC ACID” commercially available from ChemPoint, Bellevue, Wash.) resulting in a copolymer having a molecular weight of about 10,000 to about 15,000.

TABLE 2
Plasticized PLA-PGA and their glass transition temperatures.

| Expt | PLA-PGA | | Plasticizer | | T_{g} ° C. |
|---|---|---|---|---|---|
| No. | PLA-PGA | PHR | Plasticizer | PHR | (° F.) |
| 10 | PLA-PGA | 100 | N/A | N/A | 30 (86) |
| 11 | PLA-PGA | 100 | Triethyl Citrate | 13 | 12 (54) |
| 12 | PLA-PGA | 100 | Triethyl Citrate | 20 | 2 (36) |
| 13 | PLA-PGA | 100 | Triethyl Citrate | 30 | −11 (12) |

The densities of the plasticized PLA are shown in Table 3 below.

TABLE 3
Plasticized PLA and their specific gravity.

| Expt | PLA | | Plasticizer | | |
|---|---|---|---|---|---|
| No. | Amorphous PLA | PHR | Plasticizer | PHR | S.G. |
| 1 | ECORENE 60 | 100 | N/A | N/A | 1.24 |
| 3 | ECORENE 60 | 100 | Lactide | 30 | 1.2133 |
| 7 | ECORENE 60 | 100 | Triacetin | 30 | 1.1956 |
| 8 | ECORENE 60 | 100 | Tributyl Citrate | 30 | 1.1985 |

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

What is claimed is:

1. A method comprising:
reacting lactic acid, glycolic acid, or a combination thereof in a condensation reaction to form a degradable polymer;
combining the degradable polymer and a plasticizer to form a coating composition;
applying the coating composition to a downhole tool;
placing the coated downhole tool into a portion of a subterranean formation; and,
hydrolyzing the degradable polymer of the coating composition to release an acid and degrade the coating.

2. The method of claim 1 wherein the glass transition temperature of the coating composition is greater than about −15° C.

3. The method of claim 1 wherein the glass transition temperature of the coating composition is greater than about 0° C.

4. The method of claim 1 wherein the glass transition temperature of the coating composition is greater than about 35° C.

5. The method of claim 1 wherein the plasticizer selected from the group consisting of: polyethylene glycol, polyethylene oxide; oligomeric lactic acid, citrate esters (such as tributyl citrate oligomers, triethyl citrate, acetyltributyl citrate, and acetyltriethyl citrate), glucose monoesters, partially fatty acid esters, PEG monolaurate, triacetin, poly(e-caprolactone), poly(hydroxybutyrate), glycerin-1-benzoate-2,3-dilaurate, glycerin-2-benzoate-1,3-dilaurate, bis(butyl diethylene glycol)adipate, ethylphthalylethyl glycolate, glycerin diacetate monocaprylate, diacetyl monoacyl glycerol, polypropylene glycol (and epoxy derivatives thereof), poly(propylene glycol)dibenzoate, dipropylene glycol dibenzoate, glycerol, ethyl phthalyl ethyl glycolate, poly(ethylene adipate)distearate, and di-iso-butyl adipate.

6. The method of claim 1 wherein the coating composition further comprises at least one additive selected from the group consisting of: enzymes, chelants, organic acids, surface active agents, oxidizers, drilling fluids, filter cakes formed from these drilling fluids, hydraulic fracturing fluids, and high viscosity completion fluid.

7. The method of claim 6 wherein the enzyme is an esterase, lipase, or a combination thereof.

8. The method of claim 6 wherein the downhole tool is an object selected from the group consisting of a testing downhole tool, a perforating downhole tool, a completion downhole tool, a drilling downhole tool, a logging downhole tool, a treating downhole tool, a circulation valve downhole tool, a packer, a well screen assembly, a bridge plug, a frac plug, a kickoff plug, a cementing downhole tool, coil tubing, casing, and a fishing downhole tool.

9. The method of claim 1 wherein the plasticizer comprises a water resistant plasticizer selected from the group consisting of: bis(2-ethylhexyl) phthalate, diisononyl phthalate, bis(n-butyl)phthalate, butyl benzyl phthalate, diisodecyl phthalate, di-n-octyl phthalate, diisooctyl phthalate, and diethyl phthalate.

10. The method of claim 1 wherein the plasticizer comprises a temperature resistant plasticizer selected from the group consisting of: trimethyl trimellitate, tri-(2-ethylhexyl) trimellitate, and tri-(n-octyl,n-decyl) trimellitate.

11. A method comprising:
reacting lactic acid, glycolic acid, or a combination thereof in a condensation reaction to form a degradable polymer;
combining the degradable polymer and a plasticizer to form a coating composition;
applying the coating composition to a screen such that the screen openings are substantially occluded by the coating composition;
placing the coated screen into a portion of a subterranean formation; and,
hydrolyzing the degradable polymer of the coating composition to release an acid and degrade the coating.

12. The method of claim 11 wherein the glass transition temperature of the coating composition is greater than about −15° C.

13. The method of claim 11 wherein the glass transition temperature of the coating composition is greater than about 0° C.

14. The method of claim 11 wherein the glass transition temperature of the coating composition is greater than about 35° C.

15. The method of claim 11 wherein the plasticizer selected from the group consisting of: polyethylene glycol, polyethylene oxide; oligomeric lactic acid, citrate esters (such as tributyl citrate oligomers, triethyl citrate, acetyltributyl citrate, and acetyltriethyl citrate), glucose monoesters, partially fatty acid esters, PEG monolaurate, triacetin, poly(e-caprolactone), poly(hydroxybutyrate), glycerin-1-benzoate-2,3-dilaurate, glycerin-2-benzoate-1,3-dilaurate, bis(butyl diethylene glycol)adipate, ethylphthalylethyl glycolate, glycerin diacetate monocaprylate, diacetyl monoacyl glycerol, polypropylene glycol (and epoxy derivatives thereof), poly(propylene glycol)dibenzoate, dipropylene glycol dibenzoate, glycerol, ethyl phthalyl ethyl glycolate, poly(ethylene adipate)distearate, and di-iso-butyl adipate.

16. The method of claim 11 wherein the coating composition further comprises at least one additive selected from the group consisting of: enzymes, chelants, organic acids, surface active agents, oxidizers, drilling fluids, filter cakes formed from these drilling fluids, hydraulic fracturing fluids, and high viscosity completion fluid.

17. The method of claim 16 wherein the enzyme is an esterase, lipase, or a combination thereof.

18. The method of claim 11 wherein the plasticizer comprises a water resistant plasticizer selected from the group consisting of: bis(2-ethylhexyl) phthalate, diisononyl phthalate, bis(n-butyl)phthalate, butyl benzyl phthalate, diisodecyl phthalate, di-n-octyl phthalate, diisooctyl phthalate, and diethyl phthalate.

19. The method of claim 11 wherein the plasticizer comprises a temperature resistant plasticizer selected from the group consisting of: trimethyl trimellitate, tri-(2-ethylhexyl) trimellitate, and tri-(n-octyl, n-decyl) trimellitate.
